(19) United States
(12) Patent Application Publication
(10) Pub. No.: US 2023/0013245 A1
(43) Pub. Date: Jan. 19, 2023

(54) SYSTEM AND METHOD FOR STORAGE OF LIQUIDFIED AIR AT MODERATE TO HIGH INTERNAL PRESSURE

(71) Applicant: PRELOAD CRYOGENICS, LLC, Quincy, MA (US)

(72) Inventors: Sanjay Mehta, Hauppauge, NY (US); Eric T. Reaman, Hingham, MA (US)

(21) Appl. No.: 17/860,223

(22) Filed: Jul. 8, 2022

Related U.S. Application Data
(60) Provisional application No. 63/219,542, filed on Jul. 8, 2021.

(51) Int. Cl. F17C 1/02; F17C 1/12; B28B 23/02

(52) U.S. Cl. CPC F17C 1/02; F17C 1/12; B28B 23/02; F17C 2203/0678; F17C 2203/0643; F17C 2221/031; F17C 2203/0304; F17C 2209/22; F17C 2209/2109; F17C 2209/2154; F17C 2201/0109; F17C 2205/0103; F17C 2203/012; F17C 2203/0624

(57) ABSTRACT

A liquified air storage system can include a container assembly. The container assembly can be disposed on a base. The container assembly can have an interior portion and an exterior portion. The interior portion can include a reinforced concrete layer and a steel liner. The exterior portion can be disposed adjacent to the interior portion, the exterior portion including prestressed wire. A method of assembling a liquified air storage system can include assembling an interior portion of a container assembly. The interior portion can have a reinforced concrete layer and a steel liner. Next, an exterior portion of the container assembly can be assembled on the interior portion. The exterior portion can include a composite material and prestressed wires. The exterior portion can be covered with an insulation layer.

### CROSS-REFERENCE TO RELATED APPLICATIONS

This application claims the benefit of U.S. Provisional Application No. 63/219,542, filed on Jul. 8, 2021. The entire disclosure of the above application is incorporated herein by reference.

### FIELD

The disclosure generally relates to storage systems and, more particularly, to liquified air storage systems.

### INTRODUCTION

This section provides background information related to the present disclosure which is not necessarily prior art.

Liquefied air (LAIR) is used in certain energy producing systems where the LAIR is stored at a temperature of around −320 degrees F. and at a pressure of approx. 300-500 psig. Re-gasified LAIR expands (in volume) by 700+ times and this expansion of the air during a warming up process (or, regasification) can be used to spin a turbine. Increasing the volume of LAIR increases the amount of time that the turbine will spin. As such, LAIR can be efficiently used as a long duration battery when the power to liquefy the air comes from a surplus source of energy, such as solar energy or curtailed solar.

Known methods for storing LAIR include providing storage tanks. These storage tanks require certain features to adequately store LAIR in an efficient manner. Specifically, the storage tank must be made from a material that is minimally permeable to LAIR and also possesses the strength to withstand the necessary internal pressure at cryogenic temperature required to store LAIR. Current methods include using nickel-based or stainless steels. Nickel-based or stainless steels are uniquely capable of maintaining ductility and strength under high internal pressure at cryogenic temperatures beyond other types of commonly used steel. However, one major drawback for using nickel-based or stainless steels is the high cost of these materials. Also, thick steel plates required for strength and ductility under operating conditions are very difficult to fabricate and even more difficult to weld. Most of the nickel-based or stainless steel tanks are restricted in size because of difficulty in fabricating and welding thick metal sheets. Aside from the previously mentioned high cost of these steels, transportation and assembly logistics present several issues due to the size and weight of such steel storage tanks.

Accordingly, there is a need for a storage tank capable of storing LAIR made with more economical materials and which allows for lower transportation and installation costs. There is also a need to build LAIR tanks with larger capacities, where such capacities are currently impractical with the currently known metal tanks. Desirably, the storage tank would efficiently retain LAIR by reducing the permeability of the sidewalls and have the structural strength to withstand the internal pressure at cryogenic temperature necessary to store LAIR.

### SUMMARY

In concordance with the instant disclosure, a liquefied air storage system and method that is configured to be more economically constructed while also efficiently retaining LAIR by reducing the permeability of the sidewalls and having the structural strength to withstand the internal pressure necessary to store LAIR, has been surprisingly discovered.

A liquified air storage system can include a container assembly. The container assembly can be disposed on a base. The container assembly can have an interior portion and an exterior portion. The interior portion can include a reinforced concrete layer and a steel liner. The exterior portion can be disposed adjacent to the interior portion, the exterior portion including prestressed wire.

A method of assembling a liquified air storage system can include assembling an interior portion of a container assembly. The interior portion can have a reinforced concrete layer and a steel liner. Next, an exterior portion of the container assembly can be assembled on the interior portion. The exterior portion can include a composite material and prestressed wires. The exterior portion can be covered with an insulation layer.

In an exemplary embodiment, a liquified air storage system is provided that includes a container having a reinforced concrete layer, a prestressed wire, and a composite layer. The reinforced concrete layer can include an outer surface. The outer surface can be constructed from a liner of steel. In certain embodiments, the liner of steel can include a nickel-based or stainless steel. The prestressed wire can be disposed around an outer surface of the reinforced concrete layer. The composite layer can be disposed around the outer surface of the reinforced concrete layer. In a certain embodiment, the composite layer can be constructed from shotcrete. The shotcrete can also encapsulate the prestressed wire. Where the shotcrete encapsulates the prestressed wire, the container can be structurally enhanced to withstand greater pressure.

The reinforced concrete layer, along with outer surface, can have certain functionalities that can be performed by various types of material. For example, where the outer surface includes a nickel-based or stainless steel liner, the efficiency of the container can be enhanced. Without being bound to any particular theory, the use of a nickel-based or stainless steel liner can militate against the permeability of a liquified gas being stored in the liquified air storage system. In a specific example the nickel-based or stainless steel liner can be connected to the reinforced concrete layer using studs. In a specific example, the liquified gas can include liquified air (LAIR). In certain examples, a nickel-based steel including a 9% nickel content or stainless steel can be utilized for the outer surface and is believed to retain LAIR efficiently and effectively. As a non-limiting example, the steel liner can be between 1/16″-1″ thick. In a more particular, non-limiting example, the steel liner can be around 3/16″ thick. Advantageously, where the liquified air storage system uses 3/16″ thick 9% nickel-based steel, the overall cost of materials and the cost of transportation of the materials is reduced while effectively maintaining the efficiency of liquified gas retention in the liquified air storage system.

The composite layer can have certain functionalities in addition to providing corrosion protection to the prestressed wire. For example, where the composite layer encapsulates the prestressed wire disposed around the outer surface of the reinforced concrete layer, the strength of the liquified air storage system can be enhanced. In certain circumstances, the prestressed wires can be disposed around the outer surface of the reinforced concrete layer in a vertical orientation, a horizontal orientation, or both. The prestressed wire can be disposed across the entire outer surface of the reinforced concrete layer. The prestressed wire can be disposed around the outer surface of the reinforced concrete layer under tension. For example, prestressing can include where a portion of the composite layer is compressed by the prestressed wire. Certain portions of the composite layer can be prestressed during the assembly process (pre-tensioning) or portions of the composite layer can be stressed once completed (post-tensioning). Prestressing of the wires can compensate for the tensile stresses introduced in the reinforced concrete layer and composite layer when liquified gas is introduced into the liquified air storage system. Hence the composite layer can generally remain in compression. The composite layer can include concrete, mortar, and/or shotcrete encapsulating the prestressed wires. As a non-limiting example, the prestressed wires can include around 528 wires per foot, in 24 layers. With continued reference to the non-limiting example, the composite layer can include around 12″ of shotcrete encapsulating the prestressed wires. Advantageously, the prestressed wires and composite layer enhance the strength of the liquified air storage system. Desirably, the enhanced strength permits the liquified air storage system to accept the pressure of the stored liquified gas at cryogenic temperatures.

The container can be configured to retain a liquid. As non-limiting examples, the container can be substantially bullet shaped or substantially spherical shaped. In a specific example, the container can further include a pair of end caps disposed on terminal ends of the container. The end caps can be constructed from a nickel-based or stainless steel material. In certain circumstances the end caps can be constructed from 1⅝″ thick 9% nickel-based steel. The end caps can be coupled to the outer surface. In a specific example, the end caps can be coupled to the outer surface by welding the end caps to the nickel-based or stainless steel liner. In an even more specific, non-limiting example, the connection can include a full penetration groove weld with or without backing bar.

The liquified air storage system can also include an insulation layer and a jacket layer disposed around the container. The insulation layer can substantially surround the container. The insulation layer can be configured to maintain a desired temperature within the liquified air storage system. In a non-limiting example, the insulation layer can include about 3 feet of perlite insulation covering one or more of the container and the end caps. The insulation layer can be covered by the jacket layer. The jacket layer can be a protective cover configured to enhance the durability of the liquified air storage system. In a specific example, the jacket layer can include a ¾″ thick shell. Other variations can include constructing the jacket layer out of reinforced/prestressed concrete. Advantageously, the insulation layer and the jacket layer can protect the liquified air storage system from the surrounding elements such as extreme temperatures, wind, and debris.

Various ways of assembling the liquified air storage system are provided. Certain methods can include a step of providing a reinforced concrete layer, cast compositely with the steel sheet surface in sections. The sections can be circular rings stacked one above the other and then prestressed in the vertical direction using high strength galvanized strands. Alternatively, the sections can be full height vertically pretensioned panels with about 8′ width curved to the radius of the container. Where full height vertical sections are used to construct layers and, the vertical joints between the sections can be filled with shotcrete. In certain embodiments, the reinforced concrete layer can be cast-in-situ concrete walls. In another step, the combined and fully assembled reinforced concrete layer can be disposed in a position configured to retain a liquid. The prestressed wire can be disposed around an outer surface of the reinforced concrete layer in an additional step. For example, the prestressed wire can be disposed around the outer surface of the reinforced concrete layer under tension. In another step, the composite layer can be formed around the outer surface of the reinforced concrete layer and encapsulate the prestressed wire. In certain circumstances, the method can further include a step of covering the composite layer with an insulation layer. The insulation layer can then be covered with a jacket layer configured to protect the liquified air storage system in an additional step. Advantageously, the composite layer can be formed onsite where the liquified air storage system is constructed. Desirably, the onsite construction of the composite layer allows for a more convenient means of transporting the composite layer and assembling the liquified air storage system.

Advantageously, the liquified air storage system provides a more economical means of constructing a container that is configured to efficiently retain LAIR by reducing the permeability of the container and having the structural strength to withstand the pressure exerted by LAIR at cryogenic temperatures.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of a liquified air storage system, according to an embodiment of the present disclosure;

FIG. 2 is an enlarged, fragmentary schematic view of an upper portion of the liquified air storage system, as shown in FIG. 1;

FIG. 3 is an enlarged, fragmentary schematic view of a lower portion of the liquified air storage system, as shown in FIG. 1;

FIG. 4 is a schematic view of a liquified air storage system, according to another embodiment of the present disclosure; and

FIG. 5 is a flowchart of a method for manufacturing the liquified air storage system, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9,1-8,1-3,1-2,2-10,2-8,2-3,3-10,3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIGS. is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

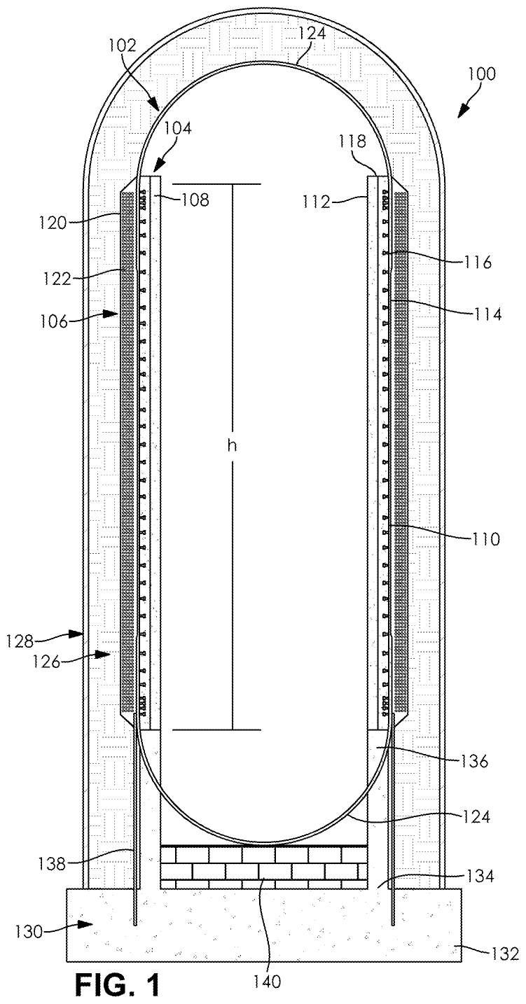

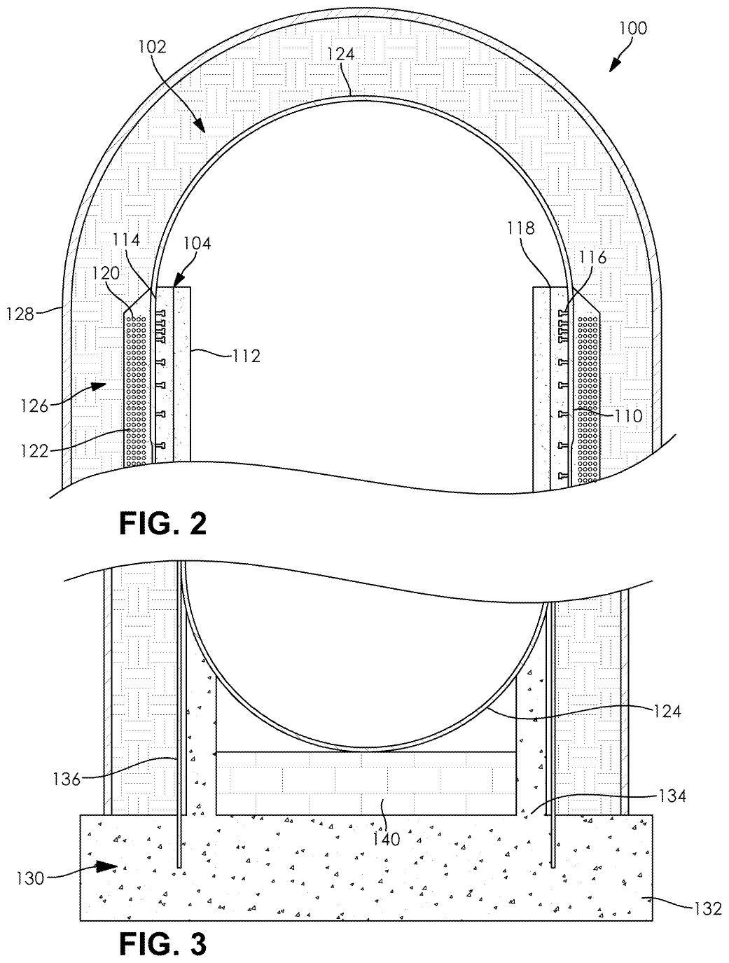

As shown in FIGS. 1-4, a liquified air storage system 100 is provided. The liquified air storage system 100 can be configured to store the liquefied air (LAIR) at a temperature of around −320° F. and at a pressure of about 300 to about 500 pounds per square inch gauge, as a non-limiting example. The liquified air storage system 100 can include a container assembly 102. The container assembly 102 can be configured to retain a liquid, such as the LAIR, as a non-limiting example. In certain embodiments, the container assembly 102 can be cylindrical, bullet shaped or spherical, as non-limiting examples. A skilled artisan can select other suitable shapes within the scope of the present disclosure.

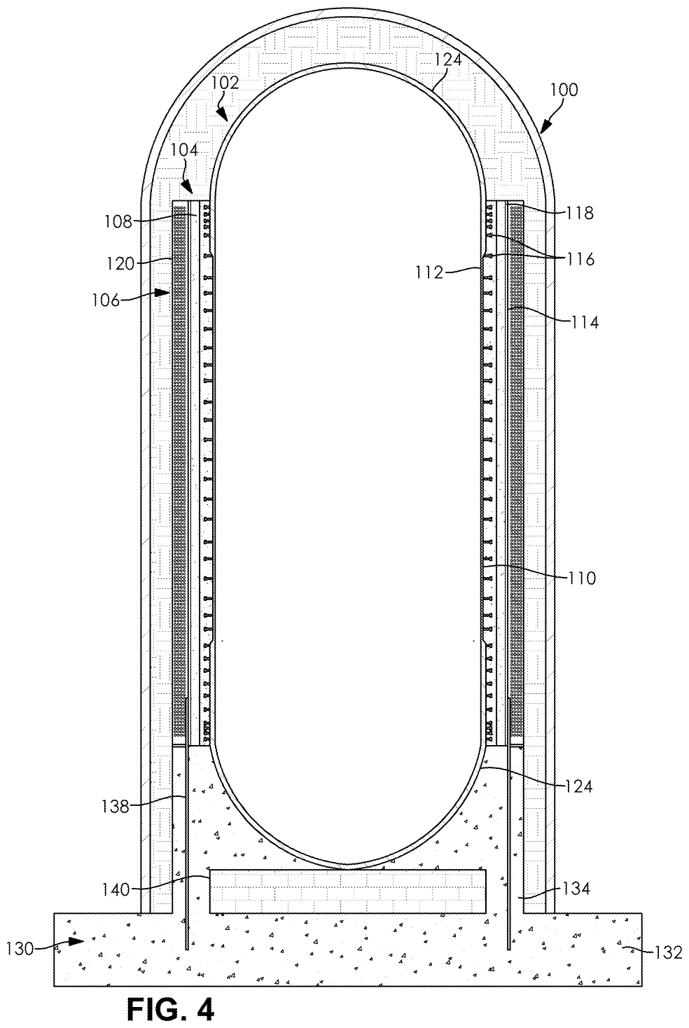

The container assembly 102 can include an interior portion 104 and an exterior portion 106 disposed adjacent to the interior portion 104. The interior portion 104 can include a reinforced concrete layer 108 and a steel liner 110. The reinforced concrete layer 108 can include an inner surface 112 and an outer surface 114. In one embodiment, shown in FIGS. 1-3, the steel liner 110 can be disposed on the outer surface 114 of the reinforced concrete layer 108. In another embodiment, shown in FIG. 4, the steel liner 110 can be disposed on the inner surface 112 of the reinforced concrete layer 108. The exterior portion 106 can be disposed on the interior portion 104. In particular, the exterior portion 106 can be disposed on one of the reinforced concrete layer 108 (e.g., FIG. 4) and the steel liner 110 (e.g., FIGS. 1-3) based on the construction of the interior portion 104.

The steel liner 110 can be secured to the reinforced concrete layer 108. In particular, the steel liner 110 can include a plurality of studs 116 formed thereon. The studs 116 can be disposed into the reinforced concrete layer 108. The studs 116 can be fabricated from nickel-based steel or stainless steel. A skilled artisan can select other suitable means and materials for securing the steel liner 110 to the reinforced concrete layer 108, as desired.

The reinforced concrete layer 108 can be fabricated from steel rebar reinforced concrete, as a non-limiting example. The reinforced concrete layer 108 can have a thickness of about 1′ to about 2′. In a particular embodiment, the reinforced concrete layer 108 can have a thickness of about 1′-9″, as a non-limiting example. A skilled artisan can select a suitable thickness for the reinforced concrete layer 108, as needed. The reinforced concrete layer 108 can be prestressed. In certain embodiments, the reinforced concrete layer 108 can include vertical tendons 118 disposed therethrough. The tendons 118 can be placed under tension, thereby, prestressing the reinforced concrete layer 108. In certain embodiments, the tendons 118 can be disposed in channels formed in the reinforced concrete layer 108. A remainder of the channel surrounding the tendons 118 can be filled with grout, as needed. The grout can be a high-strength material configured to both strengthen the reinforced concrete layer 108 and help integrate the tendons within the reinforced concrete layer 108. In particular, the high-strength grout can be a non-shrink, non-bleed grout. The high-strength grout can be selected to have a compression strength at least equal to a compression strength of the concrete used to fabricate the reinforced concrete layer 108. Other suitable materials and means for manufacturing the reinforced concrete layer 108 can also be selected, as desired.

The steel liner 110 can be fabricated from materials including a nickel-based steel or stainless steel. Advantageously, where the steel liner includes a nickel-based or stainless steel liner, the efficiency of the container assembly 102 can be enhanced. Without being bound to any particular theory, the use of a nickel-based or stainless steel liner 110 can militate against the permeability of a liquified gas (not shown) being stored in the liquified air storage system 100 through the interior portion 104 of the container assembly 102. In certain examples, a nickel-based steel including a 9% nickel can be utilized for the steel liner 110 and is believed to retain LAIR efficiently and effectively.

The steel liner 110 can have a thickness of about 1/16″ to about 1″. In a more particular, non-limiting example, the steel liner can be around 3/16″ thick. Advantageously, where the liquified air storage system 100 uses 3/16″ thick 9% nickel-based steel, the overall cost of materials and the cost of transportation of the materials is reduced while effectively maintaining the efficiency of liquified gas retention in the liquified air storage system 100.

The exterior portion 106 can include prestressed wire 120 encapsulated by a composite material 122. Prestressing of the exterior portion 106 can compensate for tensile stresses introduced in container assembly 102 when liquified gas is introduced into the liquified air storage system 100. In certain circumstances, the prestressed wire 120 can be disposed around the interior portion 104 of the container assembly 102 in a vertical orientation, a horizontal orientation, or combinations thereof. As shown in FIGS. 1-3, the prestressed wire 120 can be disposed in the horizontal direction. The prestressed wire 120 can be disposed across an entire surface of the interior portion 104 and along an entire height of the container assembly 102. As a non-limiting example, the prestressed wire 120 can include around 528 wires per foot, in 24 layers. A skilled artisan can select a suitable amount and orientation of prestressed wire 120, as desired.

The composite material 122 can include concrete, mortar, shotcrete, and combinations thereof encapsulating the prestressed wire 120. In a particular non-limiting example, the composite material 122 can include around 12″ of shotcrete encapsulating the prestressed wires 120. The composite material 122 can have certain functionalities in addition to providing corrosion protection to the prestressed wire 120. For example, where the composite material 122 encapsulates the prestressed wire 120 disposed around the interior portion, the strength of the liquified air storage system 100 can be enhanced.

The prestressed wire 120 can be disposed around the interior portion 104 of the container assembly 102 under tension. For example, prestressing can include where a portion of the composite material 122 is compressed by the prestressed wire 120. Certain portions of the composite material 122 can be prestressed during an assembly process (pre-tensioning) or portions of the composite material 122 can be stressed once completed (post-tensioning). Accordingly, the composite material 122 can generally remain in compression.

Advantageously, the prestressed wire 120 and composite material 122 enhance the strength of the liquified air storage system 100. Desirably, the enhanced strength permits the liquified air storage system 100 to accept the pressure of the stored liquified gas (not shown) at cryogenic temperatures.

The container assembly 102 can further include a pair of end caps 124 disposed on terminal ends of the container assembly 102. The end caps 112 can be constructed from a nickel-based or stainless steel material, as non-limiting examples. In certain embodiments, the end caps 124 can be constructed from 1⅝″ thick 9% nickel-based steel. The end caps 124 can be coupled to the interior portion 104. As shown in FIG. 1, the end caps 124 can be coupled to the steel liner 110. In a more specific example, the end caps 124 can be welded to the steel liner 110. In an even more specific example, the end caps 124 can be welded to the steel liner 110 via a full penetration groove weld with or without backing bar.

In certain embodiments, as shown in FIGS. 1-4, the liquified air storage system 100 can also include an insulation layer 126 and a jacket 128 disposed around the exterior portion 106 of the container assembly 102. The insulation layer 126 can substantially surround the exterior portion 106 of the container assembly 102. The insulation layer 126 can be configured to maintain a desired temperature within the liquified air storage system 100. In a non-limiting example, the insulation layer 126 can have a thickness of about 3 feet. The insulation layer 126 can include perlite insulation, as a non-limiting example. It should be further appreciated that the insulation layer 126 can also cover one or both end caps 124.

The insulation layer 126 can be covered by the jacket layer 128. The jacket layer 128 can be a protective cover configured to enhance the durability of the liquified air storage system 100. In a specific example, the jacket layer 118 can include a′/4″ thick shell. Other variations can include constructing the jacket layer 118 out of reinforced/prestressed concrete. Advantageously, the insulation layer 126 and the jacket layer 128 can protect the liquified air storage system 100 from the surrounding elements such as extreme temperatures, wind, and debris.

The liquid air storage system 100 to further include a base 130. The base 130 can be constructed from a material that militates against heat loss and that is able to withstand a high compressive load. The base 130 can include a concrete footing 132. The concrete footing 132 can be substantially cylindrical with a diameter of at least 65″. Advantageously, the concrete footing 132 with a diameter of at least 65″ can reduce the bearing pressure of the liquid air storage system to below 4500 psf. The base 130 can include a concrete skirt wall 134 extending from the concrete footing 132. The skirt wall 134 can have a thickness of about 1.5″, in certain non-limiting examples. The skirt wall 134 can define a hollow cylinder, and the container assembly 102 can be disposed therein, as shown in FIG. 3. The container assembly 102 can include a pedestal wall 136 that can be disposed on a top edge of the skirt wall 134. The container assembly 102 can be further secured to the base 130 via seismic anchor straps 138. A skilled artisan can select a suitable number of anchor straps 138 based on the dimensions of the container assembly 102 within the scope of the present disclosure.

The base 130 can include an insulative material 140 within the hollow cylinder formed by the skirt wall 134. As a non-limiting example, the insulative material 140 can be constructed from a cellular glass insulation, such as FOAMGLAS® cellular glass insulation, which is commercially available through Owens Corning (Toledo, OH). The insulative material 140 can be constructed from at least a three (3) foot thick base of the cellular glass insulation or similar insulative material. Advantageously, the increased thickness of the insulative material 140 can further militate against heat loss of the stored cryogenic liquid.

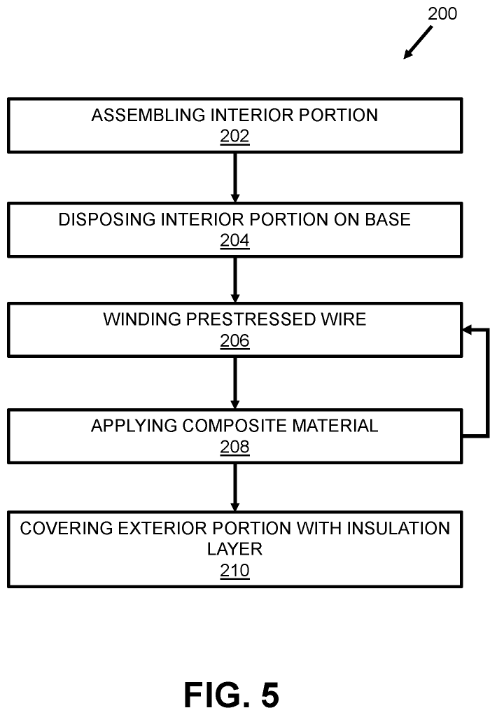

Various ways of assembling the liquified air storage system 100 are provided. As shown in FIG. 5, a method 200 of manufacturing the liquified air storage system 100 can include a step 202 of assembling the interior portion 104, which can include the reinforced concrete layer 108 cast compositely with the steel liner 110. The interior portion can be disposed in a position configured to retain a liquid. The interior portion 104 can be assembled on the base 130 or can be assembled and then disposed on the base 130, as desired, in a step 204.

In one embodiment, the interior portion can be provided in sections. The sections can be circular rings. The circular rings can include the reinforced concrete layer 108 with the steel liner 110 disposed on one of the interior surface 112 or the outer surface 114 thereof. The assembly step 202 can include stacking a plurality of the rings one above the other. The stack of rings can then be prestressed in the vertical direction using the tendons 118 described hereinabove. The tendons can then be grouted in place, as described herein.

Alternatively, the sections can be full height vertically pretensioned panels. Each of the panels can have a substantially rectangular side profile with a slightly arcuate cross section across a width of the panel. Each of the panels can have a width of about 8′. The curvature of the panels can be determined by the desired radius of the container assembly 102. Where full height vertical sections are used to construct the interior portion, the vertical joints between the sections can be filled with shotcrete. Each of the wall panels can also have a plurality of welding plates (not shown) formed into the concrete on each side of the panels. These welding plates allow the panels to be welded together when forming the interior portion 104.

In a further embodiment, the interior portion 104 can be cast-in-situ concrete walls. In particular, the steel liner 110 can be provided, and the reinforced concrete layer 108 can be cast directly to the steel liner 110.

A step can include assembling the exterior portion 106 of the container assembly on the interior portion 104. In particular, the step of assembling the exterior portion 106 can include a step 206 of winding a set of the prestressed wires 120, under tension, around a height of the interior portion 104. Another step 208 can be applying a layer of the composite material 122 over the prestressed wires 120. Steps 206 and 208 can be repeated, as needed, until a desired number of prestressed wires 102 have been wound onto the container assembly. In alternative embodiments, an entire length of the prestressed wires 120 can be wound around the container assembly 102 and then an entire amount of composite material can be applied over top of the prestressed wires 120. Advantageously, the composite layer 108 can be formed onsite where the liquified air storage system 100 is constructed. Desirably, the onsite construction of the composite layer 108 allows for a more convenient means of transporting the composite layer 108 and assembling the liquified air storage system 100.

The method 200 can further include a step 210 of covering the exterior portion 106 of the container assembly 102 with the insulation layer 126. The insulation layer 126 can then be covered with a jacket layer 128, in a step 212. The jacket layer 128 can be configured to protect the liquified air storage system 100.

Advantageously, the liquified air storage system 100 provides a more economical means of constructing a container assembly 102 that is configured to efficiently retain LAIR by reducing the permeability of the container assembly 102 and having the structural strength to withstand the pressure exerted by LAIR at cryogenic temperatures.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A liquified air storage system, comprising:
a container assembly including:
an interior portion including a reinforced concrete layer and a steel liner; and
an exterior portion disposed adjacent to the interior portion, the exterior portion including a prestressed wire.

2. The liquified air storage system of claim 1, further comprising an end cap disposed on an end of the container assembly.

3. The liquified air storage system of claim 2, further comprising an end cap disposed on another end of the container assembly.

4. The liquified air storage system of claim 1, further comprising an insulation layer disposed on container assembly.

5. The liquified air storage system of claim 4, further comprising a jacket disposed adjacent to the insulation layer.

6. The liquified air storage system of claim 1, wherein the steel liner includes nickel-based steel or stainless steel.

7. The liquified air storage system of claim 1, wherein the steel liner has a thickness of about 1/16″ to about 1″.

8. The liquified air storage system of claim 1, wherein the steel liner is fabricated from 9% nickel-based steel and has a thickness of about 3/16″.

9. The liquified air storage system of claim 1, wherein the exterior portion includes concrete, mortar, or shotcrete.

10. The liquified air storage system of claim 1, wherein the exterior portion includes a layer of shotcrete encapsulating the prestressed wire.

11. The liquified air storage system of claim 1, wherein the prestressed wire is disposed along a height of the exterior portion.

12. The liquified air storage system of claim 1, wherein the prestressed wire is under tension.

13. The liquified air storage system of claim 1, wherein the container assembly is disposed on a base.

14. A liquified air storage system, comprising:
a container assembly disposed on a base, the container assembly including:
an interior portion including a reinforced concrete layer and a steel liner, the steel liner includes nickel-based steel or stainless steel and has a thickness of about 1/16″ to about 1″; and
an exterior portion disposed adjacent to the interior portion, the exterior portion including a prestressed wire disposed under tension along a height of the exterior portion and encapsulated by shotcrete;
an end cap disposed on an end of the container assembly;
an insulation layer disposed on container assembly; and
a jacket disposed adjacent to the insulation layer.

15. A method of assembling a liquified air storage system, the method comprising the steps of:
assembling an interior portion of a container assembly having a reinforced concrete layer and a steel liner;
assembling an exterior portion on the interior portion, the exterior portion including a composite material and a prestressed wire;
covering the exterior portion of the container assembly with an insulation layer.

16. The method of claim 15, wherein the step of assembling the interior portion includes providing a plurality of circular rings, each ring having the reinforced concrete layer and the steel liner and stacking the rings vertically.

17. The method of claim 15, wherein the step of assembling the interior portion includes providing a plurality of full height vertically pretensioned panels, each panel having the reinforced concrete layer and the steel liner.

18. The method of claim 15, wherein the step of assembling the interior portion includes providing the steel liner and casting the reinforced concrete wall in-situ.

19. The method of claim 15, wherein the step of assembling the exterior portion includes winding wire under tension around a height of the interior portion to form the prestressed wire.

20. The method of claim 15, wherein the step of assembling the exterior portion includes:
winding wire under tension around a portion of a height of the interior portion to form a portion of the prestressed wire;
applying a layer of the composite material over the portion of prestressed wire; and
repeating the winding and applying until a predetermined amount of prestressed wire is wound under tension around the height of the interior portion to form the prestressed wire.
